(19) United States
(12) Patent Application Publication
(10) Pub. No.: US 2006/0138201 A1
(43) Pub. Date: Jun. 29, 2006

(54) Method of manufacturing an electronic component and apparatus for carrying out the method

(76) Inventor: Haruo Watanabe, Sakata-shi (JP)

Correspondence Address: WILLIAM COLLARD;COLLARD & ROE, P.C., 1077 NORTHERN BOULEVARD, ROSLYN, NY, 11576, US

(21) Appl. No.: 11/069,865

(22) Filed: Mar. 1, 2005

(30) Foreign Application Priority Data
Dec. 24, 2004 (JP) 2004-373832

(51) Int. Cl. B23K 31/02

(52) U.S. Cl. 228/214; 228/42

(57) ABSTRACT

An electronic-component manufacturing apparatus includes a supply mechanism that supplies a lead-frame terminal component whose fuse portion is filled with a solder material in advance, a carrier unit that carries the terminal component, a flux application unit that applies flux to the fuse portion, a preheating zone that performs preheating, and a reflow unit that performs main-heating.

This application claims priority to prior Japanese patent application JP 2004-373832, the disclosure of which is incorporated herein by reference.

### BACKGROUND OF THE INVENTION

The present invention relates to a method and an apparatus for manufacturing an electronic component.

Some electronic components including IC chips etc. have lead terminals. When the electronic components are mounted to various electronic devices or machines, the lead terminals are sometimes soldered. Prior to the soldering, the lead terminals are sometimes coated with solder in advance.

The soldering and solder coating of this type are generally performed in such a way that the lead terminals of electronic components are immersed for a fixed time in a solder bath in which a solder material circulates while overflowing. The immersion of the lead terminals in the solder bath may be performed continuously. A pump is used to make the solder material overflow the solder bath.

In soldering, irregular-shaped projections and bridges which short-circuit the lead terminals can be produced at the soldered portions. The poorly soldered portions such as the projections and bridges can be prevented from being produced by applying flux to the lead terminals in advance to decrease the surface tension of the solder and then connecting them by soldering.

Recently, flux is generally used which contains little ingredient to reduce the surface tension in consideration of limitation in use by fron (chlorofluorocarbon) restriction, Accordingly, the poor solder bonding cannot be completely prevented merely by applying flux onto a solder portion before soldering, because when the solder on the solder portion is separated from molten solder, the surface tension increases by the oxygen in the air.

Thus, in addition to the application of flux, the use of nitrogen gas is proposed as means for decreasing the surface tension of solder. In that case, the entire soldering apparatus or a soldering unit (molten solder bath) is disposed in an airtight space or airtightly sealed, into which nitrogen gas is supplied continuously to form an oxygen-deprived atmosphere, thereby preventing the solder bridge and projections.

In the case where a solder material is made overflow the solder bath, a pulsating flow or eddy due to the operation of a pump can occur in the solder material when the solder material flows out or the flowing shape of the solder material can be disturbed owing to the shape of a flexible tape used in the apparatus. In that case, the amount of the solder material in contact with the lead terminal of an electronic component becomes unstable, so that the solder can adhere to an undesired portion, the region and the thickness of the solder coating can become uneven, or a so-called bridge that short circuits the adjacent lead terminals can occur in the product.

In the case where nitrogen gas is used, the nitrogen gas is sent even to an undesired portion other than the solder portion, so that the running cost for the nitrogen gas is increased. Also, since the soldering apparatus is disposed in some airtight space, the concentration of nitrogen gas at the solder portion is decreased due to flux gas generated from the flux during soldering, resulting in poor solder bonding.

In order to solve the above problems, the inventor has proposed a solder bonding method including a first process of moving a work along a specified passage in a first direction, a second process of applying a jet of solder material from a second direction substantially perpendicular to the first direction to a specified region of the work, and a third process of blowing a high-temperature fluid onto the specified region after the second process.

However, this jet application method is not suitable to the application of solder only to a desired portion, although the entire surface of a lead frame can be coated with solder.

For example, as a method of manufacturing a fuse link or a slow-blow fuse used for vehicles such as electric motorcars, there can be a method of applying solder to a desired portion and reflow heating it through an atmosphere furnace. However, mass processing can result in variation in heat treatment condition for individuals to form solder lumpy, causing a lot of product defects in which solder is not in close contact with the surface of the fuse. Such defective fuses may not shut off electricity even at a specified current or may be blown in an instant at a current higher than a specified current. Thus, such fuses have no function of shutting off electricity in safety as slow-blow fuse, thus being of poor quality and low yield.

### SUMMARY OF THE INVENTION

Accordingly, it is an object of the present invention to provide a method of manufacturing electronic components suitable for the manufacture of electronic components such as a fuse link and a slow-blow fuse because of high solder adhesion and uniform quality.

It is another object of the invention to provide an apparatus for manufacturing electronic components for performing the method of manufacturing electronic components.

According to one aspect of the present invention, there is provided a method of manufacturing an electronic component of a lead frame type including a circuit part. The method includes disposing a solder material on the circuit part of the electronic component, and melting the solder material by a heat source to fix it to the circuit part. In the method, the heat source is a hot blast.

In the aspect of the invention, the solder material may not contain lead or a lead alloy.

According to another aspect of the present invention, there is provided a method of manufacturing an electronic component. The method includes placing a lead-frame terminal component whose fuse portion is filled with a solder material in advance to a supply mechanism; carrying the terminal component; applying flux to the fuse portion; preheating the fuse portion; and main-heating the fuse portion.

In the aspect of the invention, the solder material may not contain lead or a lead alloy.

According to still another aspect of the present invention, there is provided an apparatus for manufacturing an electronic component of a lead frame type including a circuit part.

The apparatus includes a solder fixing unit that disposes a solder material on the circuit part of the electronic component, and a heating unit that melts the solder material by a heat source to fix it to the circuit part. In the apparatus, the heat source is a hot-blast supply unit that emits hot air.

In the aspect of the invention, the solder material may not contain lead or a lead alloy.

According to yet another aspect of the present invention, there is provided an apparatus for manufacturing an electronic component.

The apparatus includes a supply mechanism that supplies a lead-frame terminal component whose fuse portion is filled with a solder material in advance; a carrier unit that carries the terminal component; a flux application unit that applies flux to the fuse portion; a preheating unit that preheats the fuse portion; and a reflow unit that main-heats the fuse portion.

In the aspect of the invention, the solder material may not contain lead or a lead alloy.

### BRIEF DESCRIPTION OF THE DRAWINGS

FIG. 1A is a plan view of the shape of a current breaking portion formed by using a soldering apparatus according to a related art;

FIG. 1B is a side view of the shape of the current breaking portion formed by using the soldering apparatus according to the related art;

FIG. 2 is a diagram of an apparatus according to an embodiment of the invention;

FIG. 3 is a front view of the essential part of the apparatus of FIG. 2;

FIG. 4 is a front view in which the flow of a lead frame in the apparatus of FIG. 2;

FIG. 5 is a side view of the essential part of the apparatus of FIG. 3;

FIG. 6 is a partial enlarged front view of an air heater part of FIG. 3;

FIG. 7A is a plan view of FIG. 6;

FIG. 7B is a side view of FIG. 6;

FIG. 8 is a sectional view of the air heater included in the apparatus of FIG. 2;

FIG. 9A is a plan view showing a current breaking portion formed by using the apparatus of FIG. 2; and

FIG. 9B is a side view of the current breaking portion of FIG. 9A.

### DESCRIPTION OF THE PREFERRED EMBODIMENT

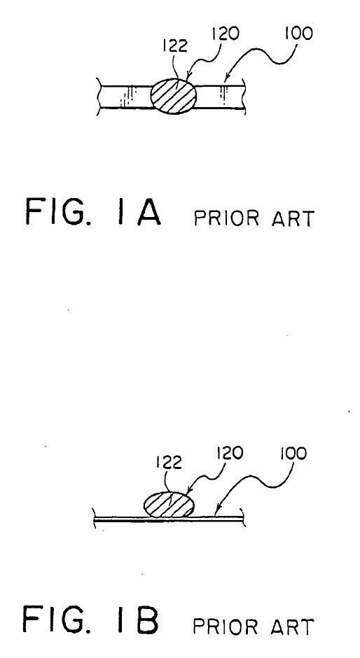

A conventional current breaking portion using a soldering apparatus will be described before a description of the preferred embodiment of the invention with reference to FIGS. 1A and 1B.

Referring to FIGS. 1A and 1B, a fuse link or a slow-blow fuse manufactured by using a related art is soldered to a circuit part 120 of a lead frame 100. However, since a large number of fuses are treated in an atmosphere furnace, the shape of the fillet of a current breaking portion 122 made of solder tends to go lumpy, as shown in FIGS. 1A and 1B. When electricity is shut off by using a fuse including the current breaking portion 122 of this shape, overcurrent state continues and then the current is shut off suddenly, so that such fuses are not safe as slow-blow fuse.

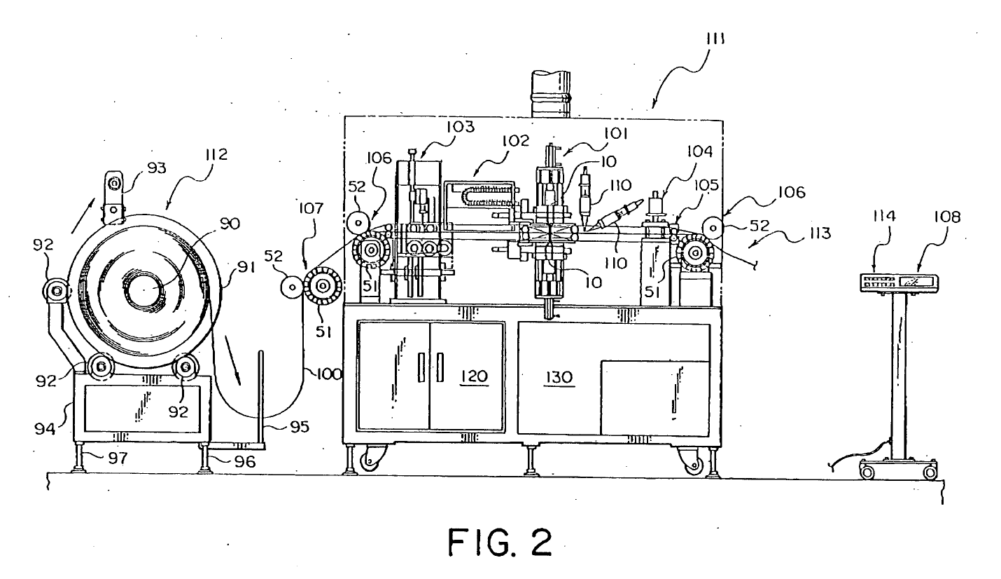

A preferred embodiment of the invention will be described below with reference to FIGS. 2 to 9A and 9B.

Referring to FIG. 2, a apparatus according to an embodiment of the invention is for manufacturing an electronic component and includes a lead-frame feed unit 112, a reflow arrangement 111, a carrier unit 113, and a control mechanism 114 for controlling the operation of the units, the portion, and the like.

The lead-frame feed unit 112 includes a supply mechanism for feeding the long lead frame 100 having a solder fuse portion serving as an electronic component. The reflow arrangement 111 fixes a solder material provided at the solder fuse portion of the electronic component to at least the solder fuse portion of the lead frame 100 by melting with heat from a heat source.

The carrier unit 113 carries the lead frame 100.

The solder fuse portion of the lead-frame type electronic component means a solder fuse portion including the portion of the circuit of the electronic component which is provided with a solder material. The solder material provided to the lead frame 100 in advance contains no lead or lead alloy, such as a tin material.

The lead-frame feed unit 112 includes a motor-driven feed reel 91 that holds the coil-shaped lead frame 100, a lead-frame supply mechanism 93 that controls the feed rate, and a leveler 95. In addition, guide rollers 92 are disposed around the motor driven feed reel 91 and provided in a support table 94 supported by supporting legs 96, 97.

The carrier unit 113 includes a torque limiter 107 and a lead-frame guide wheel 106 which are provided on the feed-in side of the reflow arrangement 111, and a lead-frame guide wheel 106 provided on the feed-out side. The torque limiter 107 and the lead-frame guide wheels 106 have a pair of lower guide wheel 51 and an upper guide wheel 52. The carrier unit 113 carries the lead frame 100 intermittently or continuously with a fixed pitch.

The reflow arrangement 111 includes a flux application unit 103, a preheating zone 102, a pair of reflow units 101, a CCD image units 110, an NG-product cutting unit 104, and a tension motor 105. Air control units are accommodated in the spaces shown by reference numbers 120 and 130 under the supporting table of the reflow arrangement.

The flux application unit 103 applies flux.

The preheating zone 102 is disposed downstream from the flux application unit 103 and serves as preheating means for preheating the solder fuse portion of the lead frame 100 at a temperature approximately 20 degrees higher than that of the outside air.

The pair of reflow units 101 is disposed downstream from the preheating zone 102 and functions as a heat source for fusing the solder material on each solder fuse portion of the electronic component (on a one-by-one spot basis) with a hot blast, or heated air, to fix it to the circuit part.

The CCD image unit 110 sorts out nonconforming solder products by image processing.

The NG-product cutting unit 104 cuts the nonconforming products sorted out by the CCD image unit 110.

The tension motor 105 applies tension to the lead frame 100.

The flux application unit 103 applies flux to the lead frame 100 with a one-shot dispenser or continuous roller application method.

The reflow units 101 include a pair of air-type reflow heaters 10 disposed to hold the solder fuse portion therebetween as heat source for fixing a solder material to the circuit part and are used as main heater.

The control mechanism 114 is provided for controlling works of each of the units and includes an operation box stand 108.

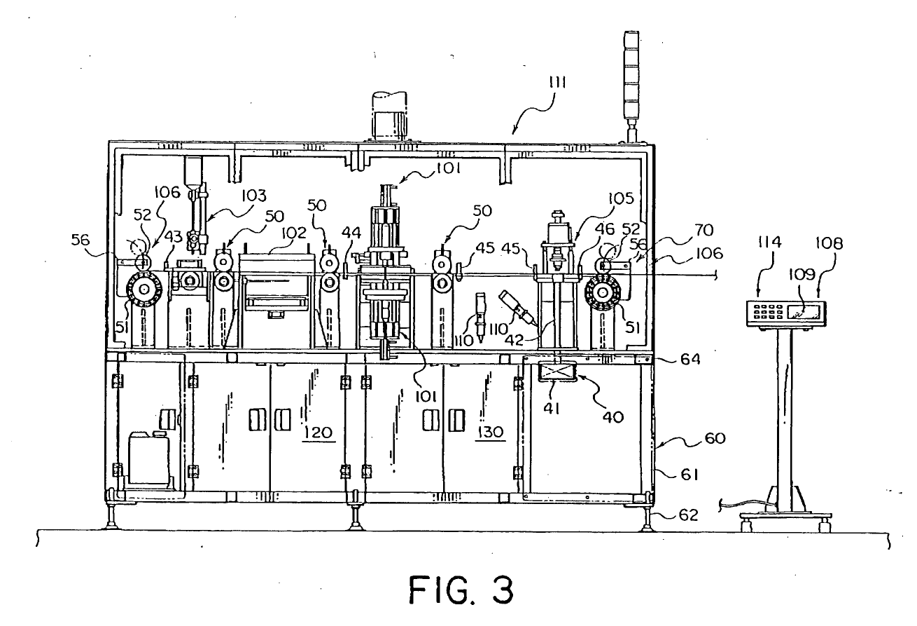

Referring to FIG. 3, the reflow arrangement 111 includes a chamber 60 having a transparent windows, a support table 64, a support frame 61, and a support legs 62. In the reflow arrangement 111, the lead-frame guide wheel 106 disposed on the feed-in side includes a lower guide wheel 51 and an upper guide wheel 52 supported by a supporting arm 56. Downstream from the lead-frame guide wheel 106, a work detector 43 is provided. Downstream from the upper guide wheel 52, the flux application unit 103 for applying flux is provided. On the downstream side thereof, the preheating zone 102 for heating the solder fuse portion to a predetermined temperature is provided with the front and rear sandwiched by carriage drive units 50. Downstream from the downstream carriage drive unit 50, a work detector 44 is disposed. The cutting unit 104 is driven by the drawing unit 40 having a solenoid coil 41 and a solenoid rod 42 driven by the solenoid unit 40. Downstream from the work detector 44, the pair of upper and lower reflow units 101 is provided. Downstream from the reflow units 101, the carriage drive unit 50 is disposed. On the downstream side thereof, the carriage drive unit 50 is disposed. Downstream from the carriage drive unit 50, two work detectors 45 are arranged with a space therebetween in the direction of the flow. Between the work detectors 45, two CCD-image processing camera units 110 are provided. Downstream from the downstream work detector 45, the NG-product cutting unit 104 is disposed. The tension motor 105 is not shown in the drawing, although the numeral thereof is shown.

Downstream thereof, a work detector 46 is disposed, through which a soldered lead frame is carried via the lead-frame guide wheel 106 similar to that on the feed-in side. The control mechanism 114 including the operation box stand 108 having a movable operation panel 109 is disposed in the vicinity of the reflow arrangement 111.

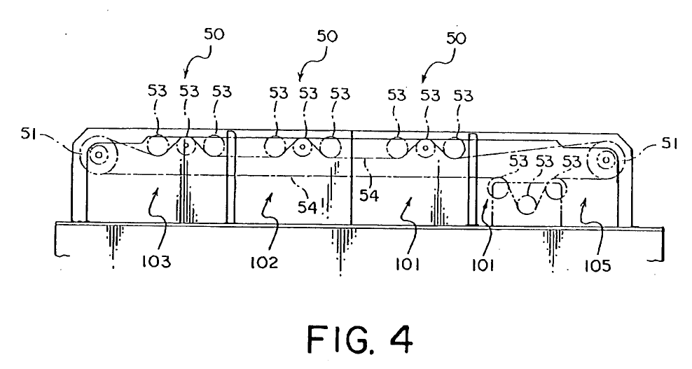

Referring to FIG. 4, three carriage drive unit 50 are disposed between the feed-in-side lead-frame guide wheel 106 and the feed-out-side lead-frame guide wheel 106, which are connected together with a timing belt 54 and driven in synchronism with one another. The carriage drive unit 50 is disposed also on the lower belt. Each carriage drive unit 50 has three kinds of sprockets 53 such that they hold the timing belt 54 from above and below alternately. While the timing belt 54 is used in the above example, a chain can be used in place of the timing belt 54. The carriage drive mechanism is not limited to that, as long as the drive mechanism is capable of synchronous drive transmission.

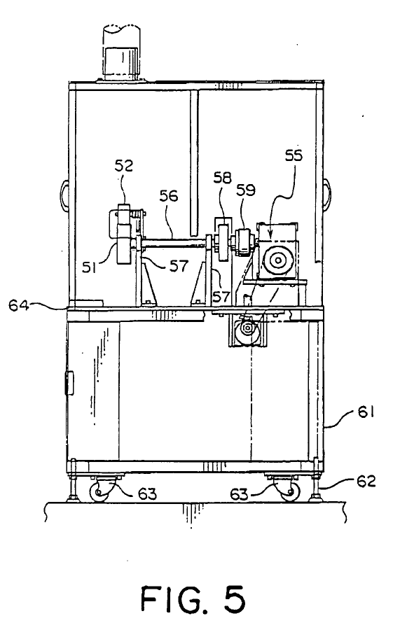

Referring to FIG. 5, the lead-frame guide wheel 106 includes the lower guide wheel 51 and the upper guide wheel 52. The lower guide wheel 51 is connected to a synchronous belt drive section 58 via a shaft 56. The synchronous belt drive section 58 is connected to a motor drive mechanism 55 via a clutch 59.

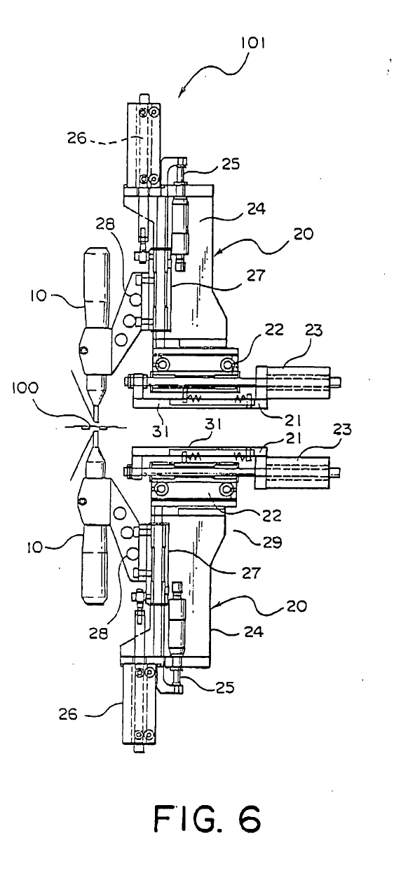

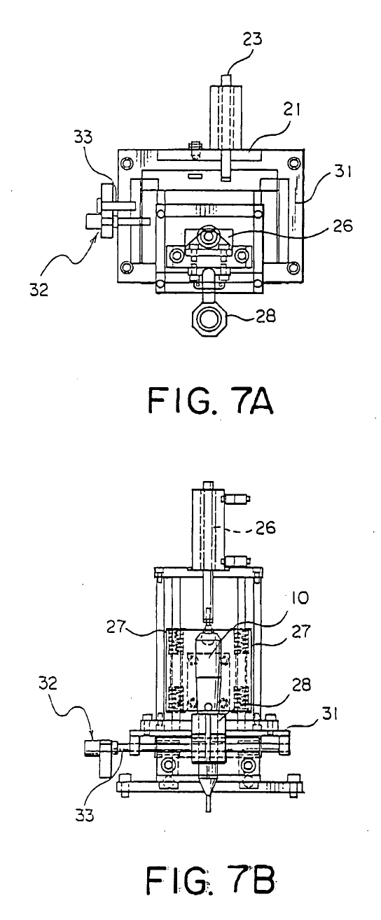

Referring to FIGS. 6, 7A, and 7B, the reflow units 101 include the pair of air-type reflow heaters 10 opposed via the lead frame 100 and their positioning mechanisms 20.

The positioning mechanisms 20 each include an X-direction positioning section 21 for positioning in the X-direction that is the carrying direction, a Y-direction positioning section 32 for positioning in the Y-direction that is the width direction, and a Z-direction positioning section 27 for positioning in the Z-direction that is the vertical direction. A supporting arm 28 holding the air flow heater 10 is fixed to the Z-direction positioning section 27.

The X-direction positioning section 21 includes a feed screw 23 for feeding a working table 31 in the X-direction relative to a supporting member 24.

The supporting member 24 is engaged to a rod of the X-direction screw 23 through a connecting portion 22. The Y-direction positioning section 32 has a positioning adjusting screw 33 for moving the working table 31 in the Y-direction relative to the supporting member 24.

The Z-direction positioning section 27 can be moved in the Z-direction relative to the working table 31 or the supporting member 24 and includes a positioning adjusting screw 26 and a fine-tune control microhead 25.

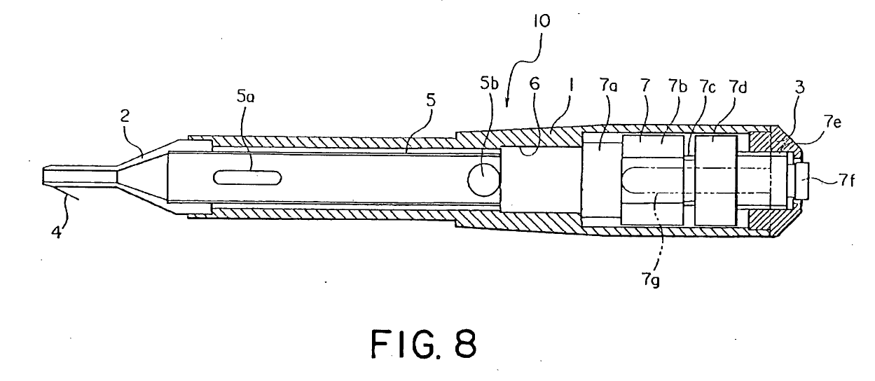

FIG. 8 is a sectional view of the air-type reflow heater 10. Referring to FIG. 8, the air-type reflow heater 10 has a cylindrical portion 1 that has a step in the center and in which the front end is larger in diameter than the rear end, a funnel-shaped front end 2 at the front end of the cylindrical portion 1, and an approximately ring-shaped rear end 3 at the rear end of the cylindrical portion 1. The front end 2 has a thermocouple for determining the temperature of an air blast. Inside the cylindrical portion 1, a cylindrical heater 5, a heater support section 6 for supporting the heater 5, and a drum-shaped holder 7 are provided. The heater 5 has a long-and-slender hole 5a and a circular hole 5b. The holder 7 is disposed at the rear end of the cylindrical portion 1 and has a fixing portion 7a for fixing the heater 5, a first large diameter portion 7b, a second large diameter portion 7d, a connecting portion 7c connecting between the first and the second large diameter portions 7b and 7d. The holder functions as an electricity and air supply section for supplying electricity and air. The air is supplied to the heater 5 in the cylindrical portion 1 through a pressurized-air supply pipe (not shown) connected to a supply port 7f at the rear end. The electricity is supplied through a lead take-off hole (not shown) that passes through the wall of the cylindrical portion 1 around the holder 7. Reference numeral 7g denotes a cord escape hole.

The air supplied from an air supply section (not shown) via the supply port 7f is heated by the heater 5, discharged from the front end, and heats the solder on the circuit part (fuse portion) of the lead frame 100 to deposit it thereon.

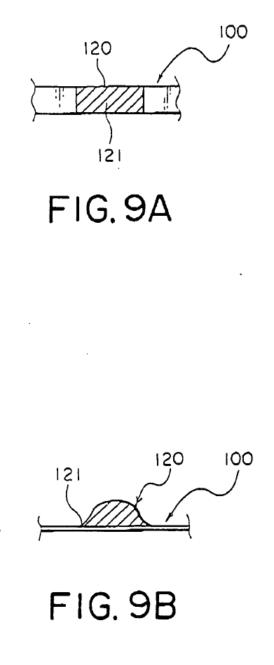

Referring to FIGS. 9A and 9B, the apparatus of FIG. 2 can make the current breaking portion of the circuit part 120 or the fuse of the lead frame 100, have a fillet, which is preferable in that the solder is deposited in the shape of a mound.

In contrast, according to the related art of FIGS. 1A and 1B, in mass processing in an atmospheric furnace, the shape of the fillet of the current breaking portion 122 made of solder tends to go lumpy. Accordingly, when electricity is shut off, overcurrent state continues and then the current is shut off suddenly, so that such fuses are not safe as slow-blow fuse. This instantaneous shuting-off causes problems in safety when the related-art fuse is used for automobiles. In contrast, the fuse manufactured by the apparatus of FIG. 2 can perform safe slow blowing.

An example of the operation of the apparatus of FIG. 2 will be described with reference to the drawings.

Tin solder is fixed by caulking to the portion (fuse portion) of the circuit part of the lead frame 100.

The lead-frame terminal component provided with the tin material is placed on the lead-frame feed unit 112 including the supply mechanism 93.

The lead frame (terminal component) 100 is carried by the carrier unit 113 intermittently or continuously (by transfer or indexing) with a fixed pitch.

Flux is applied to the solder fuse portion of the lead frame (terminal component) 100 with a one-shot dispenser or the flux application unit 103 of a continuous roller application type.

The solder fuse portion is preheated in the preheating zone 102 at a temperature approximately plus 20 degrees higher than the outside air temperature (a temperature around the preheating zone of the apparatus placed in a room), desirably, about 40 to 60° C., so as to vaporize and dry the solvent contained in the flux.

Then the fuse portion is heated on a one-by-one spot basis by the reflow units 101 including the air reflow heaters 10. At that time, the work is heated also from directions other than the fuse portion, for example, from below to stabilize reflow conditions.

The component of the above example is heated from above and below by the reflow units 101 including a pair of main heater and sub heater. Desirable reflow conditions for the pair of heaters can be set and adjusted respectively. The amount of hot air is set larger for the main heater than the sub heater.

The vertical front end of the heater unit is set at about 2 to 4 mm from the upper surface of the caulk and the lower surface of the frame.

The conditions are as follows: (1) The reflow air pressure ranges from 3 MPa to 5 MPa. (2) Hot-air discharge position of the air reflow heater can be adjusted in three dimensions. (3) The heating temperature is around 400° C. (4) The heating temperature can be controlled by controlling the applied voltage. (5) The heating time is approximately 1.5 seconds for each spot of the fuse portion.

The quality of the solder fuse portion is examined by an image processing apparatus including the CCD image unit 110.

Then defective products are press-cut by the NG-product cutting unit 104.

In the following process, the lead is rewound or ejected continuously.

Thus the soldered terminal components are manufactured.

In controlling the processes, a series of operator commands are all processed by a sequencer circuit of a computer. To change condition settings, an electronic circuit system is used which is operated by contact with the screen with a touch panel.

By the use of the method or the apparatus, it is readily possible to manufacture electronic components such as a fuse link and a slow-blow fuse because of high solder adhesion and uniform quality. The apparatus may be used as a reflowing apparatus.

As described above, the method and apparatus are most desirable for the manufacture of a circuit part of a lead frame, such as a fuse link and a slow-blow fuse.

While this invention has thus far been described in connection with the preferred embodiment thereof, it will be readily possible for those skilled in the art to put this invention into practice in various other manners without departing from the scope set forth in the appended claims.

What is claimed is:

1. A method of manufacturing an electronic component of a lead frame type including a circuit part, the method comprising:
disposing a solder material on the circuit part of the electronic component; and
melting the solder material by a heat source to fix it to the circuit part,
wherein
the heat source is a hot blast.

2. A method of manufacturing an electronic component, the method comprising:
placing a lead-frame terminal component whose fuse portion is filled with a solder material in advance to a supply mechanism;
carrying the terminal component;
applying flux to the fuse portion;
preheating the fuse portion; and
main-heating the fuse portion.

3. The method according to claim 2, wherein the carriage of the terminal component is performed intermittently or continuously with a fixed pitch.

4. The method according to claim 2, wherein the application of flux to the fuse portion is performed by a one-shot dispenser or a continuous roller application method.

5. The method according to claim 2, wherein the preheating is performed at a temperature approximately 20 degrees higher than that of the outside air.

6. The method according to claim 2, wherein the main heating is performed by air-type reflow heaters disposed to hold the solder fuse portion therebetween.

7. An apparatus for manufacturing an electronic component of a lead frame type including a circuit part, the apparatus comprising:
a solder fixing unit that disposes a solder material on the circuit part of the electronic component; and
a heating unit that melts the solder material by a heat source to fix it to the circuit part, wherein
the heat source is a hot-blast supply unit that emits hot air.

8. An apparatus for manufacturing an electronic component, the apparatus comprising:
a supply mechanism that supplies a lead-frame terminal component whose fuse portion is filled with a solder material in advance;
a carrier unit that carries the terminal component;
a flux application unit that applies flux to the fuse portion;
a preheating unit that preheats the fuse portion; and
a reflow unit that main-heats the fuse portion.

9. The apparatus according to claim 8, wherein the carrier unit carries the terminal component intermittently or continuously with a fixed pitch.

10. The apparatus according to claim 8, wherein the flux application unit applies flux by a one-shot dispenser or a continuous roller application method.

11. The apparatus according to claim 8, wherein the preheating unit performs preheating at a temperature approximately 20 degrees higher than that of the outside air.

12. The apparatus according to claim 8, wherein the main heating unit includes air-type reflow heaters disposed to hold the solder fuse portion therebetween.
